(19) United States
(12) Patent Application Publication
(10) Pub. No.: US 2011/0007307 A1
(43) Pub. Date: Jan. 13, 2011

(54) Two-Photon-Absorption Optical Filter

(76) Inventor: Joseph Daniel Vance, Scotts Valley, CA (US)

Correspondence Address: Joseph D. Vance, 316 Sherman Dr., Scotts Valley, CA, 95066, US

(21) Appl. No.: 12/499,799

(22) Filed: Jul. 9, 2009

(51) Int. Cl. G01J 3/44; G02F 1/01

(52) U.S. Cl. 356/301; 359/241

(57) ABSTRACT

A tunable optical filter includes a medium configured to perform polarization rotation on a portion of a linearly polarized signal beam having a frequency within a selected frequency band, wherein the medium is circularly birefringent within the frequency band, and wherein the polarization rotation is achieved based on two-photon-absorption. The first stage of the filter transmits a dual transmission line, and a subsequent portion of the filter partions the output of the first stage into two separate transmission channels.

### FIELD OF THE INVENTION

Embodiments of the present invention relate to optical filters designed to transmit light within a specific bandwidth range and reject light outside the specific bandwidth range, and more specifically, to remove background light from laser radar and laser communications.

### BACKGROUND OF THE INVENTION

Atomic vapor Faraday filters and Voigt filters are in common usage today as band pass filters, passing linearly polarized light at a specific narrow frequency band while rejecting light of arbitrary polarization with a frequency outside the narrow band. The filter consists of a circularly birefringent medium intermediate along the optical path between two crossed linear polarizers. The medium is circularly birefringent only for a frequency of light within the pass band, thus light outside the pass band is blocked by crossed polarizers. Light within the frequency pass band, after passing through the first polarizer, is rotated by the circularly birefringent medium, polarizing it correctly for transmission through the second polarizer. Conventional filters are limited by available transitions, and are not tunable.

Actively pumped filters and exited state filters are really just special cases of of two-photon-absorption filters which have extended the filter into new frequencies especially into the near infrared portion of the spectrum. A two-photon-absorption optical filter has been demonstrated in the prior art, but it has a dual pass band spectrum that limits it.

### BRIEF DESCRIPTION OF THE SEVERAL VIEWS OF THE DRAWING

FIG. 1 shows the energy states and transitions of Rubidium in accordance with one embodiment of the current invention.

FIG. 2 is a schematic diagram of the ultra high resolution filter in accordance with one embodiment of the current invention.

FIG. 3 shows the transmission spectrum of the first stage of the ultra high resolution filter for several different reference intensities, in accordance with one embodiment of the current invention.

FIG. 4 shows the transmission through the partitioner portion of the ultra high resolution filter for each output channel, output one channel in solid and output two channel in dotted line, in accordance with one embodiment of the current invention.

FIG. 5 shows the transmission for the first stage of the optical filter (fine) and the output channel one (bold) and output channel two (dotted) through the ultra high resolution filter in accordance with one embodiment of the current invention.

FIG. 6 shows the the components of a Raman spectrometer including the ultra high resolution filter.

### DETAILED DESCRIPTION OF THE INVENTION

Several drawings illustrate the physical attributes of an ultra high resolution optical filter and quantities that may be manifested with its construction, in accordance with one embodiment of the present invention. Examples are described that have particular gaseous mediums, transitions, wavelengths of complimentary light pairs, etc. for purposes of illustration. However, it should be noted that the choices of particular gaseous medium and particular transitions are abundant. Also, while concomitant to the chosen transitions, the wavelengths of the light pairs, test beam and reference beam, have wide latitude of choice upon a continuum. Thus it is recognized that the apparatus and means described herein may vary without departing from the basic underlying concepts of the invention.

Light that propagates through a gaseous medium is preferentially absorbed when its energy corresponds to a particular atomic transition. This preferential absorption (otherwise known as resonance absorption) also affects light phase, or dispersion. The electric susceptibility is used to describe both the absorption and dispersion effects. Whenever the real portion of the electric susceptibility, for each circular polarization state of light is different, then the medium becomes circularly birefringent. A linear polarized beam will undergo polarization rotation to another linear polarized state while traveling through a circular birefringent medium. As light travels through a circularly birefringent medium, a difference in phase between the circular polarization components accumulates over the distance of travel and polarization rotation occurs. In atomic vapors this will occur when spectral absorption lines, are shifted relative to each other, or are otherwise different, for each circular polarization state due to the physical linkage between absorption and dispersion. Quantum mechanical selection rules arising from two-photon-absorption enable absorption and dispersion for one circular polarization state of the test beam while the other circular polarization state of the test beam is excluded. It will be shown that the electric susceptibilities for the test beam that manifest from two-photon-absorption in a gaseous medium lead to circular birefringence, which can be manipulated to create an ultra high resolution filter.

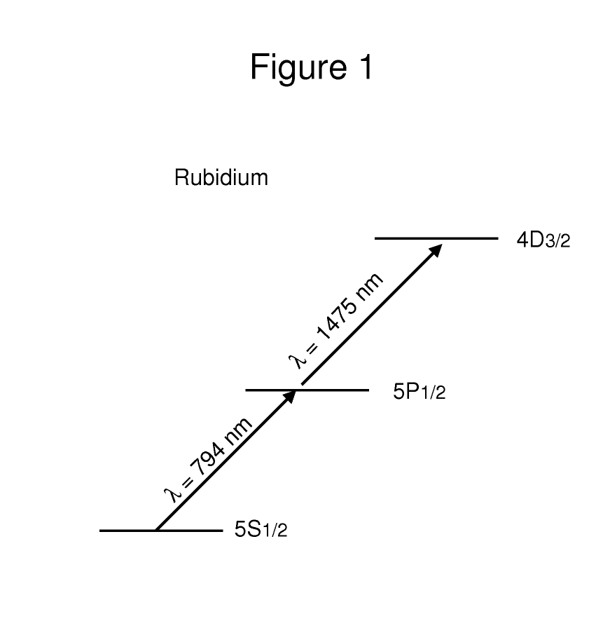

A circular birefringent medium in the present invention accomplishes circular birefringence based on a physical phenomena called two-photon-absorption. Consider an atomic transition from a ground state (lowest allowed energy state of an atom) to an intermediate excited state, which can occur with the absorption of a single photon. A single photon resonance is a photon frequency bandwidth where the energy of the photon matches an allowed atomic transition. Furthermore, consider another transition from the intermediate excited state to another still higher energy state, a final excited state that can occur with the absorption of a single photon. Two-photon-absorption is the direct transition from the ground state to the final excited state, avoiding the intermediate state, by the simultaneous absorption of two photons. A two-photon-transition identifies the states of the substance involved in two-photon-absorption. A two-photon-absorption line is a frequency bandwidth of light that can be absorbed by the process of two-photon-absorption. FIG. 1 is a diagram illustrating the process of two-photon-absorption, in accordance with one embodiment of the present invention.

In the case of two-photon-absorption, the only restriction upon the energy of the photons is that the sum of their energies match the total energy of the atomic transition:

$${E}_{excited} - {E}_{ground} = \frac{hc}{{λ}_{1}} + \frac{hc}{{λ}_{2}} \qquad Equation 1$$

Equation (1) demonstrates that there is some freedom of choice of wavelengths λ₁ & λ₂. Conservation of energy requires only that the sum of the two photon energies match the two photon transition, which is a considerably relaxed condition compared to a sequential transition, where each photon energy individually matches the transition energy. This enables tuning of the filter to different wavelengths. In this manner, the two-photon-absorption line frequency location is tunable simply by tuning the reference light frequency. Single photon resonance is not required, nor excluded in the two-photon-absorption process.

Practical two-photon-absorption involves the rigid application of angular momentum selection rules. Because conservation of angular momentum is absolute, selection rules place restrictions upon the interaction of light with matter, and are exploited to produce circular birefringence. In units of , all photons have an angular momentum. Since angular momentum is a vector, it has magnitude and direction. A photon with right-handed circular polarization has an angular momentum direction opposite to the propagation direction, and a magnitude of one. A photon with left-handed circular polarization has an angular momentum direction in the same direction as the propagation direction, and a magnitude of one. Circularly polarized light is in a stationary or eigen state. Linearly polarized light on the other hand has angular momentum of one, but the direction is in a super position of eigen states. Upon absorption of a photon the angular momentum vector is transferred into the system that absorbs it. But in the case of linearly polarized light, the direction of the transferred angular momentum vector is equally likely to be in the forward direction as the backwards direction.

For atomic dipole transitions, or allowed transitions, there is a change in magnitude of angular momentum between the initial state and final state of one, with the emission or absorption of a single photon. Consider a sequence of two dipole transitions of an atom. Beginning with lowest energy state of the atom, the ground state, a transition can occur to an excited state, denoted here as an intermediate excited state, with absorption of a photon. Then another transition can occur from the intermediate excited state to a final excited state with another photon absorption. By vector addition, angular momentum that the ground state and the final excited state have may differ by zero or two (e.g., 1−1=0; 1+1=2). Now consider the same situation except that instead of sequential absorption of two photons there is simultaneous absorption of two photons, denoted two-photon-absorption. If the angular momentum of the atom's ground state and final excited state are identical, then two-photon-absorption can occur only with a photon pair that have angular momentum vectors aligned in opposite directions. Similarly, if the angular momentum of the atom's ground state and the final excited state differ by two, then two-photon-absorption can occur only with a photon pair that have angular momentum that is aligned in the same direction. Extrapolating from single photons to beams, all the photons of a circularly polarized beam of light have their angular momentum vectors aligned in the same direction. Here, the reference beam is circularly polarized, so two-photon-absorption can occur only with one circular polarized component of the test beam.

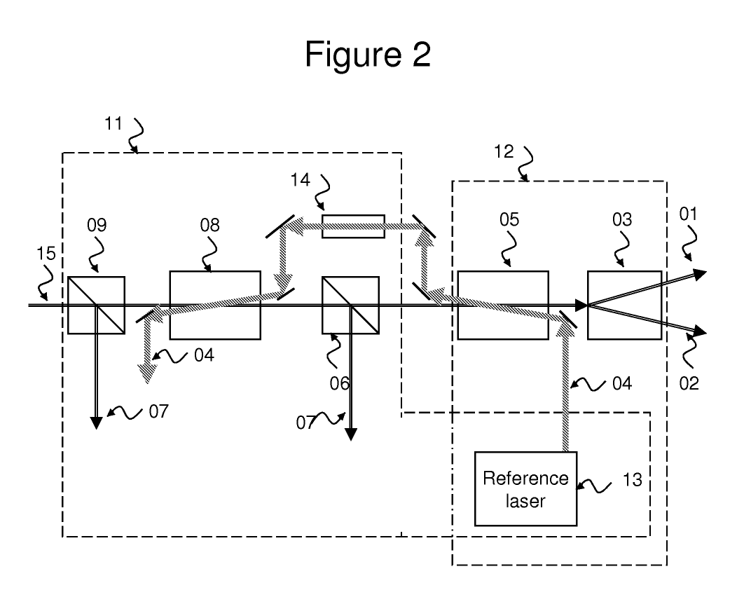

Applying the above concepts we can begin to explain the present invention. FIG. 2 illustrates the major components that operate as an optical filter, in accordance with one embodiment of the present invention. A gaseous substance involved in the two-photon-absorption process is contained in cell 05 and cell 08. For example cells 05 & 08 may be a transparent vessel that contains rubidium, some of which will be in a vapor state. A heater and a temperature controller may be implemented to control the temperature of the vapor. An example set of states and corresponding transition energy wavelengths for the Rubidium are: 5S_{1/2}→5P_{1/2}→4D_{3/2} with 794 nm and 147 respectively. Thus a reference laser may have a wavelength near 794 nm that provides a circularly polarized reference beam propagating through cells 05 & 08. There will then be a two-photon-absorption line for a test beam 15 near 1475 nm. Since the reference beam 04 is circularly polarized, the selection rules dictate there will be a two-photon-absorption line for only one circularly polarized component of test beam 15. Thus a two-photon-absorption line influences one circular component of the test beam 15, and the other circular component is unaffected making the medium circularly birefringent.

An absorption line affects light not only by absorption, but affects light phase as well. The electric susceptibility is used to describe both effects. To quantify the birefringence, the electric susceptibility can be used and is defined here in terms of dielectric polarization density:

\vec{P}=εₒχ\vec{E} Equation 2

Where the electric susceptibility χ is the proportionality constant linking the electric field of the test beam 03 to the dielectric polarization, and εis the permittivity of free space. The electric susceptibility χ is dimensionless and also a complex quantity, and is expressed in component form as:

χ=χ′+iχ″ Equation 3

The polarization of test beam 03 may will be linear after transmission through the first linear polarizer 09. Using a circular polarization basis to express the linear polarized test beam 03, with some minor approximations and removing time dependence, the electric field of the test beam 03 after traveling a distance l within a birefringent medium is:

$$\vec{E} ( l ) = - \frac{{E}_{o}}{\sqrt{2}} exp [ i \{ \frac{ω}{c} ( 1 + \frac{{χ}_{+}^{′}}{2} + i \frac{{χ}_{+}^{′′}}{2} ) l \} ] \hat{+} + \frac{{E}_{o}}{\sqrt{2}} exp [ i \{ \frac{ω}{c} ( 1 + \frac{{χ}_{-}^{′}}{2} + i \frac{{χ}_{-}^{′′}}{2} ) l \} ] \hat{-} \qquad equation ( 3 )$$

Where ω is the angular frequency and c is the speed of light. Equation (3) demonstrates that χ′, the real portion of the electric susceptibility, affects phase, while χ″, the imaginary portion of the electric susceptibility, is related to absorption. The subscripts, plus and minus, attached to the susceptibilities identifies to which circular polarization state the electric susceptibility applies to: right and left handed polarization, respectively. Notice that the field vector is written in a circular polarization basis.

The ultra high resolution filter includes a first polarizer 09 and second polarizer 06 that are in crossed orientation relative to each other. The test beam 15 is directed to pass through both crossed polarizers, therefore light that is polluting the test beam does not undergo polarization rotation and is blocked. The light that is intended to pass through, the specific frequency bandwidth, is linearly polarized after the first polarizer 09. This linear polarized light can be expressed in a different basis as components of two circularly polarized vectors. Consequently, one circular polarization state experiences absorption and dispersion while the other does not resulting in polarization rotation. The ultra high resolution filter includes a circular birefringent medium that is intermediate between linear polarizer 09 and linear polarizer 06 that are in crossed orientation relative to each other. The birefringent medium includes a gaseous substance such as an atomic vapor contained in a vapor cell 08. The birefringent medium also includes reference laser beam 04 emanating from reference laser 13. The reference laser beam 04 is circularly polarized and spatially overlaps the test beam 15 within the vapor cell 08. The gaseous substance portion of the birefringent medium may be Rubidium inside the vapor cell 08 with transparent windows. Some of the Rubidium will be in a vapor state. The reference laser 13 may be a Ti:sapphire laser and have wavelength near 794 nm. The birefringent medium will rotate the polarization of a specific frequency bandwidth of light with a wavelength near 1475 nm. The choice of laser and transmission wavelengths are made in respect to transitions of the vapor inside vapor cell 08. The atomic transition pair, and the corresponding photon wavelength pair may be chosen from many possibilities among atomic vapors and their available transitions. The wavelength of the light of the reference laser 13 may, but need not correspond to the transition wavelength required for a single photon transition. However intensity required to rotate the complimentary tuned test beam 15 will increase as the square of the difference between transition resonance frequency and the reference laser 13 frequency.

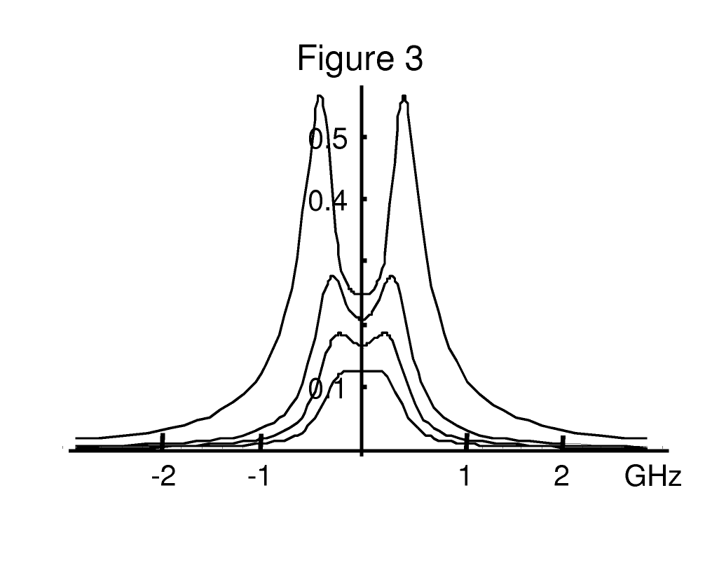

The first stage 11 of the ultra high resolution filter includes the first and second polarizers 09 & 06, the cell 08 containing a gaseous substance, and the reference beam 04 emanating from the reference laser 13 as described above. The transmission through the first stage 11 of the ultra high resolution filter with different reference intensities is shown in FIG. 3. The first stage 11 of the of the ultra high resolution filter is an optical filter in its own right, but it has deficiency. The transmission spectrum of FIG. 3 has a camel back shape with a depression near the center frequency. On either side of the depression, the transmission of light at frequencies near the camel humps can be increased or decreased depending upon several quantities. Discounting passive loss at medium interfaces, transmission near 100% can be attained for frequencies near the camel hump peak portions of the first stage 11 transmission spectrum. But at frequencies near center of the camel back region, the maximum transmission that can be attained is 25%. This ceiling in transmission can be explained in simple terms is as follows: Light having frequency near the center depression, will be experience absorption for one circular polarization state but not the other circular polarization state. One circular component will be completely removed and one circular component will remain. One half of the remaining circularly polarized light will transmit through the second polarizer 06. Thus one half the light is lost through absorption and one half the remaining light is lost upon transmission through the polarizer 06 resulting in a total maximum transmission of 25%.

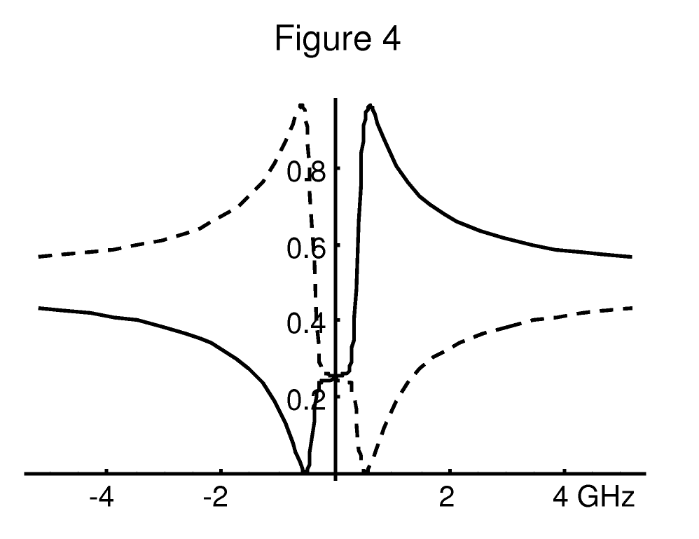

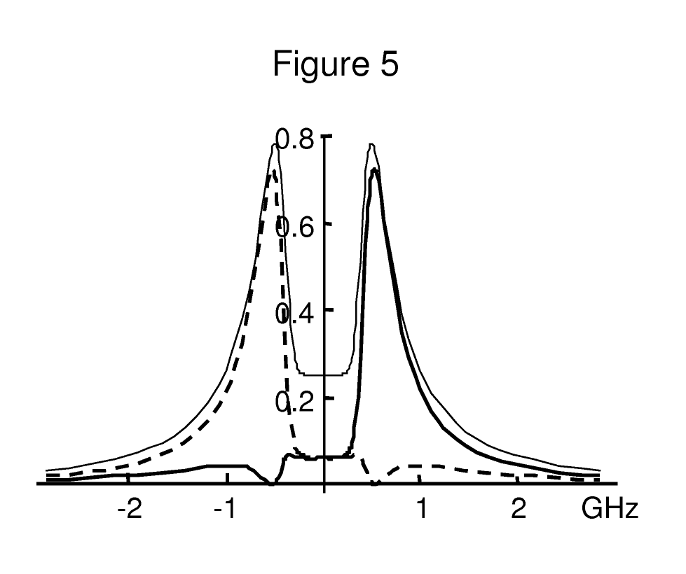

The partitioner 12 following the first stage 11 addresses the deficiency in the transmission spectrum. The portion of the test beam 15 that passes through the first stage 11 of the ultra high resolution filter encounters and propagates through another circularly birefringent medium inside cell 05. The circular birefringent medium of the partitioner 12 includes a gaseous substance such as an atomic vapor inside vapor cell 05. The circular birefringent medium of the partitioner 12 may also include reference laser beam 04 emanating from the reference laser 13. Light passing through the first stage 11 of the ultra high resolution filter will undergo polarization rotation but the direction of rotation will depend upon frequency. Referring the transmission spectrum of FIG. 3, Light with frequency near the one camel hump will rotate in the opposite direction as light near the other camel hump. After propagating through the circular birefringent medium in the partitioner 12, the rotated light encounters a polarizing beam splitter 03 such as a Wollaston prizm. The polarizing beam splitter may be oriented with an angle of approximately forty-five degrees relative to the second polarizer 06. The polarizing beam splitter 03 will split light into two different paths, output one 01 and output two 02, partitioning the light according to frequency and angle. FIG. 4 shows the transmission spectrum into each output channel of the polarizing beam splitter 03 for incident light as a function of frequency. With respect to FIG. 4, the bold line is the transmission function of output one 01, the dotted line is the transmission function of output two 02, through the partitioner 12 portion of the optical filter. When combined with the first stage 11 of the filter, the partitioner 12 subdivides the spectrum yet again producing two ultra high resolution filter pass band channels. FIG. 5 shows the total transmission through the ultra high resolution filter: in bold is output channel one 01, in dotted is output channel two 02 and for reference in fine is the transmission through the first stage 11.

There may be situations where only one channel is desired. In that case, a linear polarizer may be substituted for the polarizing beam splitter 03 or one channel may just be discarded. Also, in general a different amount of intensity from laser beam 04 will be optimum for the first stage 11 of the filter as compared to the partitioner 12 portion of the filter. Therefore a telescope 14 may be included in the system to adjust intensity of reference beam 04.

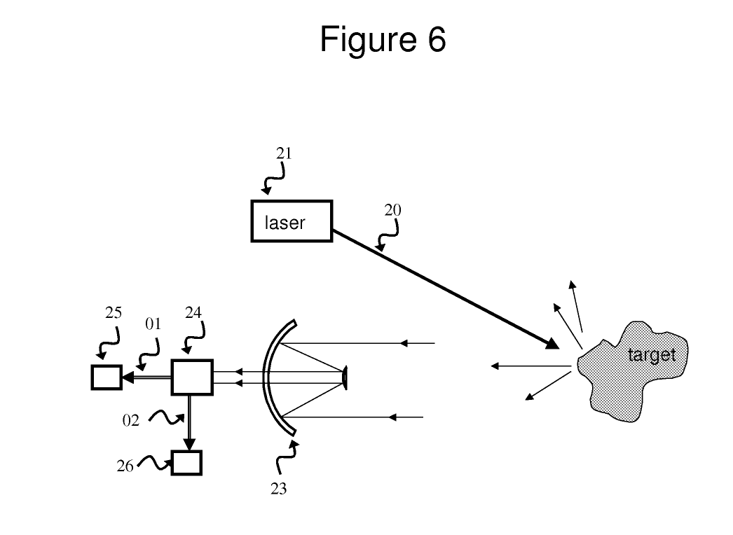

Two output channels has particular utility for Raman spectroscopy. FIG. 6 is a schematic diagram of a Raman scattering spectrum analyser. A transmitter laser beam 20 from a transmitter laser 21 may be incident upon the some target, from which the transmitter light is scattered and may return to a receiver 23, then to be directed through the ultra high resolution filter 24. Some of the light will be elastically scattered, and some of the light may be inelastically scattered. If the frequency of an inelastically scattered photon corresponds to the pass band frequency of the ultra high resolution filter it may be detected. As the transmitter laser is frequency scanned, a Raman scattering spectrum may be generated by recording into detector 25 and detector 26 the magnitude of the return signal in each channel as a function of frequency. Each channel, output one 01 and output two 02 will contain information on the scattering spectrum that can be combined to produce a more accurate measurement of inelastic scattering as a function of frequency.

What is claimed is:

1. An optical filter acting upon a test beam, comprised of:
a) a first transparent cell containing a first gaseous substance;
b) a reference laser that supplies a laser beam of circular polarization; wherein the first gaseous substance and the reference laser beam combine to create first circularly birefringent medium that performs polarization rotation within a selected frequency pass band portion of the test beam;
c) a first linear polarizer configured to linearly polarize the tests beam along a first polarization axis before the test beam passes through the birefringent medium;
d) a second linear polarizer having a second polarization axis that is approximately perpendicular to the first polarization axis, wherein the second linear polarizer is configured to receive the test beam that has passed through the first birefringent medium, to reject frequency portions of the test beam that have not undergone polarization rotation and to transmit frequency portions of the test beam that have undergone polarization rotation;
e) a second transparent cell containing a second gaseous substance, wherein the second transparent cell is configured to receive the test beam portion that is transmitted through the second polarizer;
wherein the the second gaseous substance and the reference laser beam combine to create a second circularly birefringent medium that performs polarization rotation upon the test beam portion that is transmitted through the second linear polarizer.

2. The optical filter of claim 1 further comprising:
a polarizing beam splitter that accepts the test beam after it propagates through the second gaseous substance, to a portion the test beam into two distinct beam paths according to its polarization and frequency.

3. The optical filter of claim 1 further comprising:
a linear polarizer that accepts the test beam after it propagates through the second gaseous substance, to transmit a portion test beam and to remove a portion of the test beam according to its polarization and frequency.

4. A Raman spectrometer including the optical filter of claim 2 and further comprising:
(a) a tunable transmitter laser that is directed at a target that scatters the transmitter laser light;
(b) a telescope that collects light scattered from the target and directs the scattered light into the optical filter;
(c) a first detector that collects light emanating from the first output channel of the optical filter;
(d) a second detector that collects light emanating from the second output channel of the optical filter;
wherein, the tunable transmitter is frequency scanned and the first detector and second detector records the magnitude of optical signal received as a function of transmitter frequency to create a Raman spectrum;
whereby the Raman spectrum from the output channels, output one are output two are displaced an amount equal to the frequency difference between output one and output two;
wherein the Raman spectrums from output one and output two are frequency shifted so that the information they contain coinside, and the Raman spectrums combined to produce a composite Raman spectrum.

5. A method of determining Raman shifts of a target that includes the Raman spectrometer of claim 4 comprising:
scanning the frequency of the transmitter laser that is directed upon the target;
receiving the scattered light from the target;
filtering the scattered light through the optical filter;
collecting the test beam light into two channels, output one and output two;
recording the magnitude of test beam light into detector one and detector two as a function of transmitter frequency to create Raman spectrums, output one Raman spectrum and output two Raman spectrum;
combining the information contained in output one Raman spectrum and output two Raman spectrum to build a composite Raman spectrum of the target.
